(19) United States
(12) Patent Application Publication
(10) Pub. No.: US 2026/0323239 A1
(43) Pub. Date: Oct. 15, 2026

(54) Acoustic Joining of Two or More Physical or Virtual Environments

(71) Applicant: Apple Inc., Cupertino, CA (US)

(72) Inventors: Aidan G. Meacham, San Francisco, CA (US); Dirk Schroeder, San Jose, CA (US)

(21) Appl. No.: 19/531,446

(22) Filed: Feb. 5, 2026

Related U.S. Application Data
(60) Provisional application No. 63/789,061, filed on Apr. 15, 2025.

(51) Int. Cl. H04S 7/00

(52) U.S. Cl. CPC H04S 7/305; H04S 7/40

(57) ABSTRACT

Some embodiments described herein may include acoustic joining of two or more physical or virtual environments. In one embodiment, a method may include obtaining at least a first mesh data structure representing a first environment, and a second mesh data structure representing a second environment, and generating a merged mesh data structure. The merged mesh data structure may represent a merged environment that joins the first environment with the second environment at a joined location. The method may also include determining a transfer function between locations of the first environment and the second environment in the merged environment, and modifying an acoustic signal originating at a first location with the transfer function to produce a modified acoustic signal to be played back at a second location. Other aspects are also described and claimed.

### RELATED APPLICATIONS

This application claims the benefit of priority of U.S. Provisional Application No. 63/789,061, filed Apr. 15, 2025, which is herein incorporated by reference.

### BACKGROUND

### Field

This disclosure relates generally to acoustic modeling and, more specifically, to acoustic joining of two or more physical or virtual environments. Other aspects are also described.

### Background Information

Acoustic energy, or sound, propagating (or traveling) in an acoustic environment or space, e.g., a room, may reflect from surfaces of the room (e.g., walls) and/or from surfaces of objects within the room, such as tables, chairs, curtains, etc. The acoustic energy may be heard to dissipate over time as it travels through the air (or other medium), reflecting from one or more surfaces, and/or becoming absorbed by the surfaces. This phenomenon, where a sound emitted in an environment is followed by an audible tapering of acoustic energy, is often referred to as reverberation. Reverberation occurs naturally in places by varying amounts. For example, more reverberation may occur in an indoor environment such as a room, whereas less reverberation may occur in an outdoor environment such as a park. Moreover, some places may be designed to optimize reverberation for the physical space, such as a concert hall designed for a performance. Other places may be designed to reduce reverberation in the physical space, such as an anechoic chamber. Reverberation may also be generated electronically by performing audio processing operations, e.g., digital signal processing (DSP) upon audio signals to provide a listener with a sense of space to the sound.

Sound that is emitted within an environment may include several components. For instance, some acoustic energy may travel directly from a sound source to a listener, which may be referred to as direct sound. Other acoustic energy may reflect from one or more surfaces before being heard by the listener. This acoustic energy may include early reflections and late reflections and can be referred to as reverberation.

Ray tracing is an algorithm that can be performed by a computer to simulate how energy (for example, light or sound) propagates in a physical space. The energy can be represented by rays that are emitted and traced in the simulated space. Tracing each ray provides information as to how energy will travel in such an environment. Ray tracing can be used for graphical rendering such as for film and video games, as well as lighting design, engineering, and architecture. Ray tracing can also be used for audio processing. For example, ray tracing may be utilized to model sound reflections, reverberations, diffractions, and/or scattering within a room.

### SUMMARY

Implementations of this disclosure include generating a merged mesh data structure based on merging two or more mesh data structures representing different physical or virtual environments. The merged environment may enable determining transfer functions describing the acoustic relationship between two or more locations within the environments. This may enable multiple users to have a common acoustic experience as though the users were in the same acoustic space. Some implementations may include generating and using acoustic meshes in connection with physically installed monocular conferencing systems. For example, a camera may be used to generate an acoustic mesh, then used locally to enhance audio algorithms and/or communicate with other devices to unlock experiences for physical and/or virtual attendees. Other enhancements are also described.

Some implementations may include a method for acoustic joining of two or more physical or virtual environments, including: obtaining at least a first mesh data structure representing a first environment and a second mesh data structure representing a second environment; generating a merged mesh data structure based on the first mesh data structure and the second mesh data structure, the merged mesh data structure representing a merged environment that joins the first environment with the second environment at a joined location; determining a transfer function between locations of the first environment and the second environment in the merged environment; and modifying an acoustic signal originating at a first location with the transfer function to produce a modified acoustic signal to be played back at a second location.

Some implementations may include a system for acoustic joining of two or more physical or virtual environments, including: a microphone; a sound output transducer; and a processor configured to: obtain at least a first mesh data structure representing a first environment and a second mesh data structure representing a second environment; generate a merged mesh data structure based on the first mesh data structure and the second mesh data structure, the merged mesh data structure representing a merged environment that joins the first environment with the second environment at a joined location; determine a transfer function between locations of the first environment and the second environment in the merged environment; and modify an acoustic signal originating at a first location with the transfer function to produce a modified acoustic signal to be played back at a second location. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system for acoustic joining of two or more physical or virtual environments.

FIG. 2A is an example of first environment.

FIG. 2B is an example of a second environment.

FIG. 3 is an example of a merged environment.

FIG. 4A is another example of first environment.

FIG. 4B is another example of a second environment.

FIG. 5 is another example of a merged environment.

FIG. 6 is an example of a sequentially merged environment.

FIG. 7 is an example of a nested merged environment.

FIG. 8 is an example of environment estimation.

FIG. 9 is an example of system hardware of a device for acoustic joining of two or more physical or virtual environments.

FIG. 10 is an example of a process for acoustic joining of two or more physical or virtual environments.

### DETAILED DESCRIPTION

Users may receive audio signals from many sources. For example, users that are geographically separate from one another may communicate via teleconferencing or video conferencing. A teleconference enables users to listen to one another in real time. A video conference may include a teleconference with video so that the users can also see one another. Traditional teleconferences utilize a sound output system in which sound emitted from a loudspeaker in a first user's environment may sound to the first user like the second user speaking in the second user's environment. In another example, users may connect performances in remote environments, such as concerts, sporting events, etc., to their own local environment. With traditional systems, sound in a user's environment may sound to the user like the music, sports, etc. in the remote environment What is needed is a system that adapts the sound received by users in way that improves experiences for the users.

Implementations of this disclosure address problems such as these by generating a merged mesh data structure based on merging two or more mesh data structures representing different physical or virtual environments. The merged environment may enable determining transfer functions describing the acoustic relationship between two or more locations within the environments. This may enable multiple users to have a common acoustic experience as though the users were in the same acoustic space. Some implementations may include generating and using acoustic meshes in connection with physically installed monocular conferencing systems. For example, a camera may be used to generate an acoustic mesh, then used locally to enhance audio algorithms and/or communicate with other devices to unlock experiences for physical and/or virtual attendees. Other enhancements are also described.

As described herein, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands). A virtual environment may include an XR, AR, MR, or VR environment.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

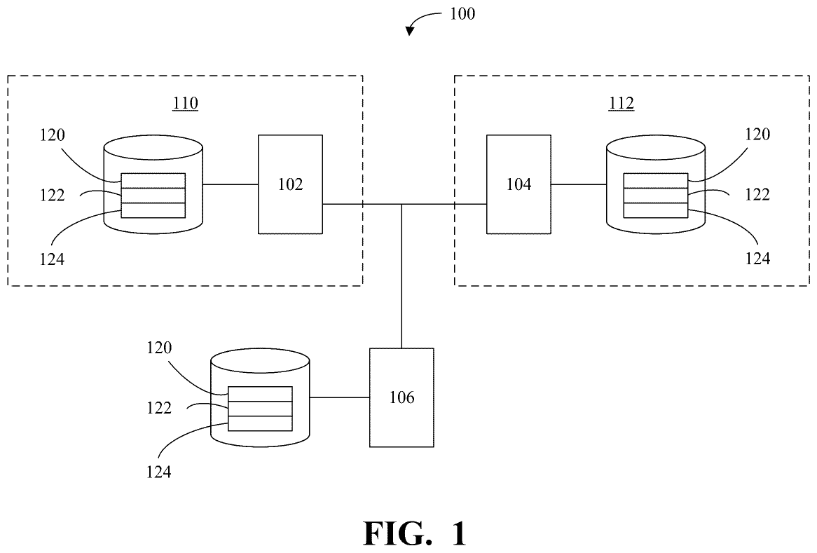

FIG. 1 is an example of a system 100 for acoustic joining of two or more physical or virtual environments. The system may include a first device 102 operated by a first user in a first environment 110, a second device 104 operated by a second user in a second environment 112, and a server device 106. While two devices in two environments (and one server device) are shown and described by way of example, it should be appreciated that numerous devices and/or environments may be present and/or merged in the system 100.

The first device 102 and the second device 104 may be operating locally with respect to their environments. The environments may be physical, virtual, or a combination thereof. For example, the first environment 110 may be a physical environment, such as a first conference room, and the second environment 112 could be another physical environment at another geographic location, such as a second conference room. In other examples, one or both of the environments could be virtual environments, such as an XR, AR, MR, or VR environment generated by an HMD. The first device 102 and the second device 104 may each include a microphone, a sound output transducer (e.g., a loudspeaker), a camera, a network interface, and/or a processor configured to execute instructions stored in a non-transitory machine-readable storage medium. The server device 106 may be operating remotely, e.g., in the cloud, or may be implemented by functionality of the first device 102 or the second device 104. The server device 106 may enable a teleconferencing or video conferencing between the first device 102 and the second device 104.

To perform acoustic joining of physical or virtual environments, the first device 102 may obtain a first mesh data structure 120 representing the first environment 110 and a second mesh data structure 122 representing the second environment 112. In some cases, the first device 102 may generate the first mesh data structure 120. This may include the first device 102 obtaining a first RGB-D image capturing the first environment 110, executing depth and segmentation estimation algorithms to approximate an acoustic mesh for objects in the space (e.g., generating a 3D model representation comprised of interconnected polygons, including of walls, furniture, users, etc.) and determining ray tracing to the objects in space based on the acoustic mesh (e.g., geometric simulations). In some cases, this may also include the first device 102 generating a prediction of features beyond a field of view captured by the first RGB-D image to complete the first mesh data structure 120. In some cases, the first device 102 may utilize a generic mesh data structure representing the first environment 110 (e.g., a generic conference room with a rectangular table and one user). In some cases, the generic mesh data structure may be dynamically generated by the first device 102 or obtained from a library. The first device 102 may send the first mesh data structure 120 that it determines to use to another device, such as the second device 104 or the server device 106.

Further, the first device 102 may receive the second mesh data structure 122 from another device, such as the second device 104 or the server device 106. Like the first device 102, the second device 104 may also obtain the first mesh data structure 120 representing the first environment 110 and the second mesh data structure 122 representing the second environment 112. In some cases, the mesh data structures (e.g., the first and second mesh data structures 120 and 122, respectively) may be the same between the devices. In other cases, one or more of the mesh data structures may be different between the devices. Like the first device 102, the second device 104 may generate the second mesh data structure 122. This may include the second device 104 obtaining a second RGB-D image capturing the second environment 112, executing depth and segmentation estimation algorithms to approximate an acoustic mesh for objects in the space (e.g., generating a 3D model representation comprised of interconnected polygons, including of walls, furniture, users, etc.), and determining ray tracing to objects in the space based on the acoustic mesh (e.g., geometric simulations). In some cases, this may also include the second device 104 generating a prediction of features beyond a field of view captured by the second RGB-D image to complete the second mesh data structure 122. In other cases, the second device 104 may utilize a manually created or authored mesh data structure representing the second environment 112, or a generic mesh data structure representing the second environment 112 (e.g., a generic conference room with a round table and one user). The authored or generic mesh data structure may be dynamically created by a user, generated by a machine (e.g., the second device 104) or obtained from a library. The second device 104 may send the second mesh data structure 122 that it determines to use to another device, such as the first device 102 or the server device 106. The second device 104 may also receive the first mesh data structure 120 from the other device.

The first device 102 may then generate a merged mesh data structure 124 based on the first mesh data structure 120 and the second mesh data structure 122. The merged mesh data structure 124 may represent a merged environment that joins the first environment 110 with the second environment 112 at a joined location. The first device 102 may send the merged mesh data structure 124 that it determines to another device, such as the second device 104 or the server device 106. The first device 102 may utilize the merged mesh data structure 124 to determine transfer functions between locations of the first environment 110 and the second environment 112 in the merged environment. For example, the first device 102 can utilize an acoustic simulator to determine a transfer function based on the merged mesh data structure 124 (e.g., the first device 102 can run acoustics simulations using the merged mesh data structure 124). The first device 102 may then modify acoustic signals originating at locations (e.g., picked up by microphones in the second environment 112, and/or a generated or prerecorded acoustic signal determined to originate at a particular location in the second environment) with the transfer functions to produce modified acoustic signals to be played back at a second location (e.g., by a sound output transducer in the first environment 110). For example, the first device 102 may utilize a spatial audio renderer to customize sound to the first environment 110 using the modified acoustic signals generated with the transfer functions. In some cases, the acoustic signal may be modified and played back to emulate a virtual sound source positioned in the merged environment, e.g., a virtual speaker, musical instrument, etc. The first device 102 may send the merged mesh data structure 124 that it determines to another device, such as the second device 104 or the server device 106. The second device 104 may do the same in the second environment 112.

In some cases, the server device 106 may generate the merged mesh data structure 124 based on the first mesh data structure 120 and the second mesh data structure 122 that it receives. The server device 106 may send the merged mesh data structure 124 to the first device 102 and/or the second device 104. In some cases, the server device 106 may apply the merged mesh data structure 124 (and perform acoustic simulations using the transfer functions based on the merged mesh data structure 124) to modify acoustic signals to produce modified acoustic signals for first environment 110 and the second environment 112.

In some cases, a device in the system 100 (e.g., the first device 102, the second device 104, or the server device 106) may send one or more parameters of the first mesh data structure 120, the second mesh data structure 122, or the merged mesh data structure 124. The one or more parameters may quantify one or more acoustic properties of the environment corresponding to the mesh data structure, such as reverberation time (e.g., a measurement indicating an amount of time for a sound pressure level to reduce by x dB, such as a reduction of 60 dB for RT 60), volume, surface area, free path (e.g., a distribution of values), mean free path (e.g., a single number value), distribution of materials parameters, absorption, or scattering of acoustic energy.

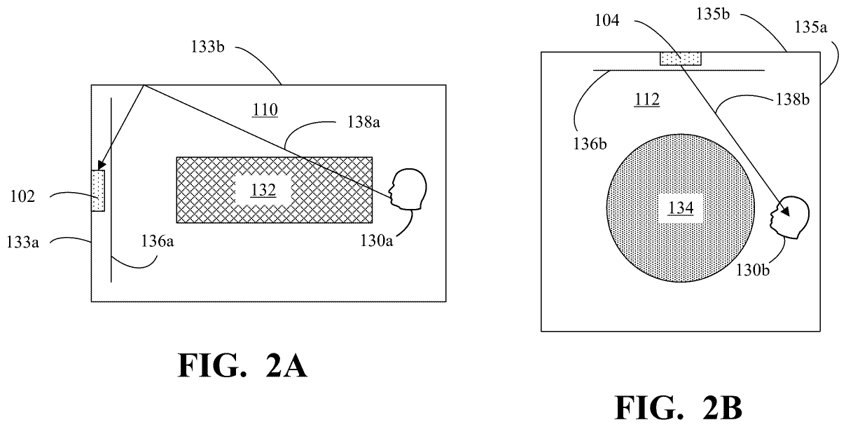

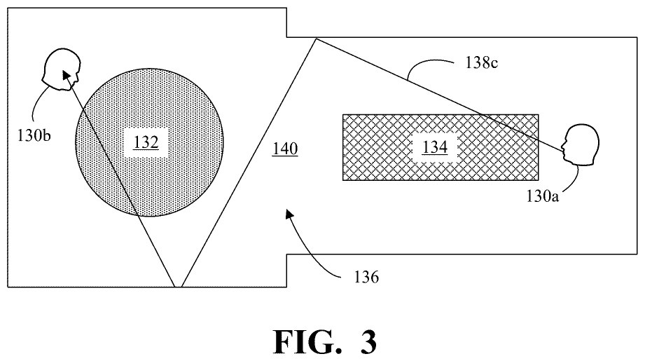

Reference is now made to FIGS. 2A, 2B, and 3 illustrating a first example of acoustic joining of environments, e.g., conference rooms. FIG. 2A is an example of the first environment 110, e.g., a first conference room. The first environment 110 may include a first user 130a at a first location near a rectangular table 132 facing a camera of the first device 102, mounted on a first wall 133a of the first environment 110. The first mesh data structure 120 may represent a mesh model the first environment 110. Further, the first user 130a or a device in the system 100 may determine an area of the first environment 110 for a first joined location 136a or first portal, such as adjacent the first wall 133a.

FIG. 2B is an example the second environment 112, e.g., a second conference room. The second environment 112 may include a second user 130b at a second location near a round table 134 facing a camera of the second device 104, mounted on a first wall 135a of the second environment 112. The second mesh data structure 122 may represent a mesh model of the second environment 112. Further, the second user 130b or a device in the system 100 may determine an area of the second environment 112 for a second joined location 136b, such as adjacent the first wall 135a.

FIG. 3 is an example of a merged environment 140 that joins the first environment 110 with the second environment 112 at a joined location 136 (portal) determined for each of the environments (e.g., converging at the first and second joined locations, 136a and 136b, respectively). Acoustically, this may correspond to a larger conference room. The merged mesh data structure 124 may represent the merged environment 140 that joins the first environment 110 with the second environment 112 at the joined location 136. This may enable the rendered acoustics experienced by the first user 130a and the second user 130b to be based on the merged mesh data structure 124.

For example, a microphone of the first device 102 may pick up an acoustic signal 138a in the first environment 110, e.g., speech of the first user 130a reflecting from a second wall 133b of the first environment 110, shown in FIG. 2A, or a generated or prerecorded acoustic signal may be determined to originate at a particular location in the first environment 110. Traditionally, this might result in an acoustic signal 138b played back by a sound output transducer of the second device 104 in the second environment 112 shown in FIG. 2B (e.g., a sound output to the second user 130b that sounds like the first user 130a speaking in the first environment 110 with the wall reflection). With acoustic joining of the environments as described herein, the second device 104 can modify the acoustic signal 138b, e.g., based on a transfer function determined using the merged mesh data structure 124 (between a first location of the first user 130a (speaking) in the first environment 110 and a second location of the second user 130b (listening) in the second environment 112) to produce a modified acoustic signal 138c. This may be determined based on a simulated acoustic path using the merged mesh data structure 124. The acoustic signal 138b may be modified by a DSP function of the second device 104. The modified acoustic signal 138c may be played back (e.g., by the sound output transducer of the second device 104) with a sound output that sounds to the second user 130b like the first user 130a speaking in the merged environment 140 shown in FIG. 3, e.g., with a second wall reflection based on a trajectory in the merged environment 140. As a result, the first user 130a in the first environment 110, and the second user 130b in the second environment 112, may each experience sound having a common room acoustic property (e.g., reverberation, such as an RT60 parameter) based on the merged mesh data structure 124.

In some implementations, the first device 102 may display a first video stream (live or prerecorded) at the first joined location 136a in the first environment 110. For example, the first video stream may correspond to images captured by the camera of the second device 104. Similarly, the second device 104 may display a second video stream (live or prerecorded) at the second joined location 136b in the second environment 112. The second video stream may correspond to images captured by the camera of the first device 102. This may enable the users to visualize the merged environment 140 corresponding to the acoustic merging that occurs, at the joined location 136. Further, in some cases, the first device 102 may render or display a first non-video component at the first joined location 136a, and the second device 104 may render or display a second non-video component at the second joined location 136b. A non-video component may include rendered graphics or any other visual rendering technique that represents the connected space. A non-video component can be viewed by users in an environment from any angle. This may enable the users to visualize other content at the joined location 136, such as Gaussian splats, avatars, physical objects, etc.

In some implementations, the first device 102 may receive input from the first user 130a that indicates the area of the first environment 110 for the first joined location 136a (e.g., adjacent the first wall 133a). Similarly, the second device 104 may receive input from the second user 130b, which indicates the area of the second environment 112 for the second joined location 136b (e.g., adjacent a second wall 135b). In some cases, the first device 102 may receive an algorithmic analysis, state change, or metadata of the first environment 110 that indicates the area of the first environment 110 for the first joined location 136a. Similarly, the second device 104 may receive an algorithmic analysis, state change, or metadata of the second environment 112 that indicates the area of the second environment 112 for the second joined location 136b.

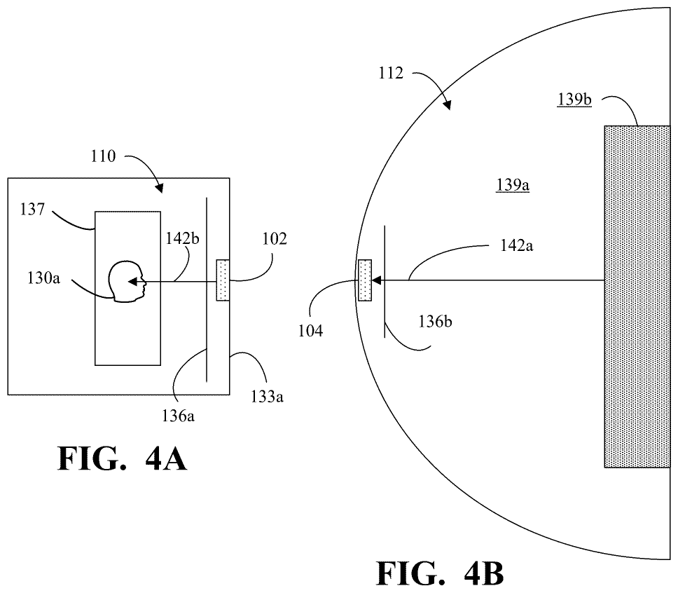

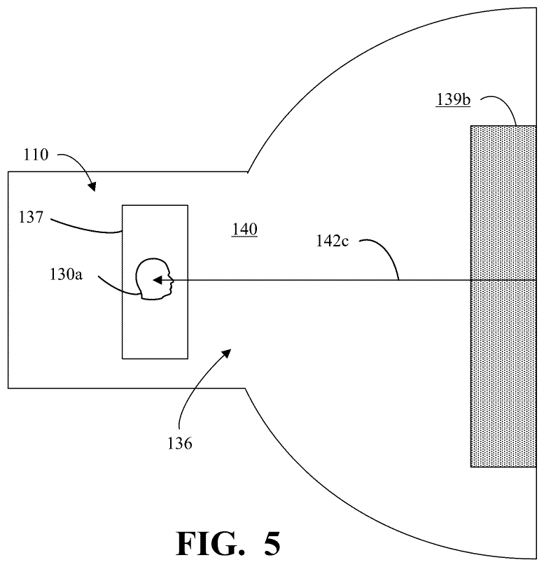

Reference is now made to FIGS. 4A, 4B, and 5 illustrating a second example of acoustic joining of environments, e.g., a living room opened to a concert hall or stadium. FIG. 4A is an example of the first environment 110, e.g., the living room. The first environment 110 may include the first user 130a at a first location (on a sofa 137) facing a camera of the first device 102 mounted on the first wall 133a of the first environment 110. The first mesh data structure 120 may represent the first environment 110. Further, the first user 130a or a device in the system 100 may determine the area of the first environment 110 for the first joined location 136a, e.g., adjacent to the first wall 133a.

FIG. 4B is an example of the second environment 112, a concert hall or stadium. The second environment 112 may include a large seating area 139a, and a performance stage or athletic field 139b, captured by a camera of the second device 104 mounted in the second environment 112. The second mesh data structure 122 may represent the second environment 112. Further, the concert hall or stadium, or a device in the system 100, may determine an area of the second environment 112 for a second joined location 136b, such as adjacent the camera.

Further, as described above, one or more of the environments that are joined may be virtual environments. For example, the second environment 112 could be a virtual space, concert hall, stadium, or other environment that is created by a user, generated by a device, or obtained from a library, as opposed to captured by a camera. Also, the microphone may be a physical or virtual microphone, and the sound output transducer (e.g., loudspeaker) could be a physical or virtual sound output transducer. For example, a virtual microphone and/or a virtual sound output transducer, positioned in the merged environment 140, may not be coincident with a location of a user. The user could listen, e.g., play back on their physical sound output transducer (e.g., an HMD), to an acoustic signal detected by the virtual microphone. This may be a modified acoustic signal played back by the virtual sound output transducer, modified according to the transfer function between the two locations. Additionally, it should be appreciated that the system may support a mixing of such physical and virtual environments, such as the first environment 110 being a physical (actual) environment captured by a camera, and the second environment 112 being a virtual (generated) environment determined by a user or device.

FIG. 5 is an example of a merged environment 140 that joins the first environment 110 with the second environment 112 at a joined location 136 (portal) determined for each of the environments (e.g., converging at the first and second joined locations, 136a and 136b, respectively). Acoustically this may correspond to a living room with one wall opened up to the concert hall or stadium to simulate private box seating. The merged mesh data structure 124 may represent the merged environment 140 that joins the first environment 110 with the second environment 112 at the joined location 136.

For example, a physical or virtual microphone of the second device 104 may pick up acoustic signals 142a in the second environment 112, e.g., the music performance, sporting event, crowd noise, etc., at a plurality of locations, shown in FIG. 4B, or a generated or prerecorded acoustic signal may be determined to originate at a particular location in the second environment 112. Traditionally, this might result in an acoustic signal 142b played back by a sound output transducer of the first device 102 in the first environment 110 shown in FIG. 4A (e.g., a sound output to the first user 130a that sounds like the music, sports, crowds, etc. in the concert hall or stadium). With acoustic joining of the environments as described herein, the first device 102 can modify the acoustic signal 142a, e.g., based on a transfer function determined using the merged mesh data structure 124 (between locations of the music, sports, crowds, etc. in the second environment 112 and the location of the first user 130a in the first environment 110) to produce a modified acoustic signal 142c (e.g., based on a simulated acoustic path using the merged mesh data structure 124, which may be used, for example, for de-reverberation). The acoustic signal 142a may be modified by a DSP function of the first device 102. The modified acoustic signal 142c may be played back (e.g., by a physical or virtual sound output transducer of the first device 102) with a sound output that sounds to the first user 130a like the music, sports, crowds, etc. in the merged environment 140 shown in FIG. 5 (e.g., their living room opened up to the concert hall or stadium at the precisely defined location). Further, the first user 130a in the first environment 110 may experience sound having a common acoustic (e.g., reverberation) with the music, sports, crowds, etc. in the second environment 112 based on the merged mesh data structure 124.

In some implementations, the merged mesh data structure 124 may be updated based on changes to the first mesh data structure 120, the second mesh data structure 122, and/or one or more additional mesh data structures. For example, a third user may enter the first environment 110 at a third location, causing a change in sound absorption due to their body and clothing. The first mesh data structure 120 may update based on detection of the third user at the third location. This, in turn, may cause the merged mesh data structure 124 to update, resulting in one or more transfer functions to be updated. In another example, the third user may be in a third environment requesting to join the first environment 110 and the second environment 112 at another joined location. Upon granting the request, the merged mesh data structure 124 may update based on an addition of a third mesh data structure (representing the third environment) to the first mesh data structure 120 and the second mesh data structure 122. This, in turn, may cause one or more transfer functions to be updated.

Thus, it should be appreciated that that two or more physical or virtual environments may be acoustically merged in many different ways. For example, FIG. 6 illustrates a sequentially merged environment 140 that includes a first environment 110, a second environment 112, and a third environment 113, in series with one another. The first environment 110 may be merged with the second environment 112 at a first joined location, and the second environment 112 may be merged with the third environment 113 at a second joined location, with the second environment 112 in between the first environment 110 and the third environment 113. Here, the second environment 112 may have joined locations 136 to different environments on opposing walls (shown in dashed lines). Further, a user in any one of the environments can provide user input to flexibly arrange the environments to achieve a desired effect, including input via a graphical user interface (GUI).

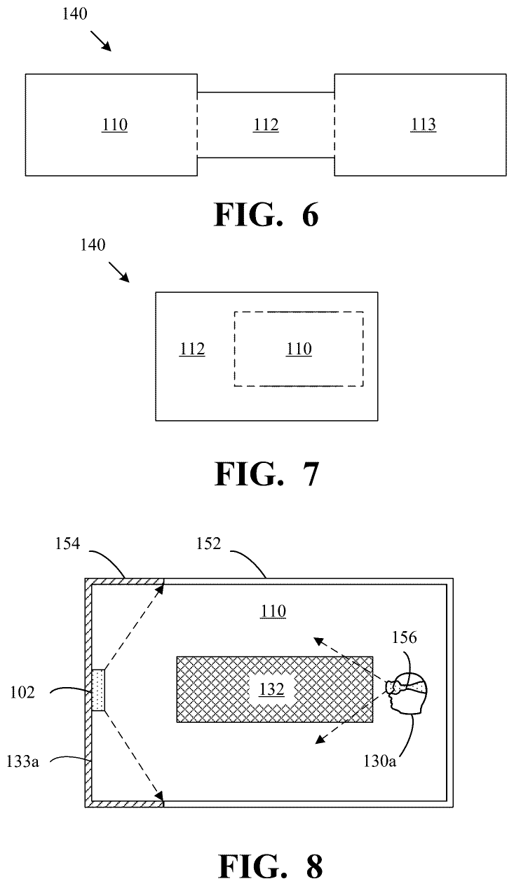

Moreover, the acoustic merging of environments need not be confined by physical laws of nature. For example, FIG. 7 illustrates a nested merged environment 140 in which a first environment 110 is acoustically positioned within a second environment 112. Here, the joined location 136 surrounds the first environment 110 on a plurality of sides and/or a plurality of corners (shown in dashed lines). This may be analogous to the living room of FIG. 4A positioned in the middle of the concert hall or stadium of FIG. 4B (as opposed to a side, like an audience member). Other examples may include environments stacked vertically with respect to one another, and one or more environments floating in three dimensional space of another environment.

In some implementations, a machine learning (ML) model may be utilized to improve one or more mesh data structures and, in turn, the merged mesh data structure 124. For example, unsensed parts of an environment (e.g., beyond a field of view of the image) may be estimated and completed based on a prediction from a trained ML model. This may enable a complete mesh data structure representing the environment to be utilized. Additionally, the mesh data structure may be updated based on other viewpoints, such as another camera of another device entering the environment. For example, FIG. 8 illustrates an environment estimation used to generate the first mesh data structure 120 to represent the first environment 110. The first device 102 may be a physically installed monocular conferencing system with a camera mounted on the first wall 133a. The first device 102 may capture features 152 within a field of view of an RGB-D image of the camera (sensed parts of the environment), then generate a prediction of features 154, beyond a field of view captured by the image. The prediction may be based on the features 152 and/or the first user 130a. This may enable the first device 102 to complete the first mesh data structure 120 representing the first environment 110 (which is then used by the merged mesh data structure 124). The mesh data structure may also be updated based on other viewpoints, such as a camera of a third device 156 (e.g., a laptop camera, HMD, etc. of the third user) capture the features 154 within a field of view of an RGB-D image of the camera of the third device 156.

Thus, in embodiments described herein, the system 100 may provide geometric connections between acoustics meshes, such as the first mesh data structure 120 and the second mesh data structure 122. The acoustic meshes may be sensed or authored mesh data structures which may be connected for enhanced playback experiences by the users, e.g., combining two or more spaces or environments, such as the first environment 110 and the second environment 112. The connected environments may be simulated as a unified acoustic scene of the merged environment 140 by merging the discrete meshes at one or more joined locations, e.g., the joined location 136, a portal representing a surface of acoustic energy exchange. Sound sources can travel freely between the environments without a transition, such as between the first user 130a and the second user 130b, or the first user 130a and the music performance, sporting event, crowd noise, etc. The merged mesh data structure 124 may include the joined location 136 representing a polygon or multiple polygons or other shapes in which the first and second mesh data structures meet. Further, more than two environments can be connected by placing multiple joined locations in the environment and/or by connecting environments sequentially, e.g., FIG. 8. The joined location 136 can be Euclidean (e.g., a hull of volume union; mesh “merging”) or non-Euclidean (e.g., a joined location floating in space). The environments (e.g., the first environment 110 and/or the second environment 112) can be sensed and exchanged over a network (e.g., via server device 106), such as between wearable devices (e.g., a head-mounted display (HMD), glasses, smartwatch, headphones, etc.). In some cases, the environments may be authored and/or downloaded for a customized, immersive experience. The joined location 136, or portal, may be placed by a device of the system via scene understanding, and/or may be controlled by a user (e.g., the first user 130a or the second user 130b). For example, scene understanding placement may include using a wall classification to determine the joined location. In some cases, MR experiences may utilize local pathfinding to determine scene understanding placement which may be hidden. In some cases, the system can further interface with acoustic models that do not include mesh data structures but which are capable of acoustic energy exchange. Descriptors of the local and connected model, such as volume, absorption area, etc., may be used in connection with the joined location 136 geometry to achieve a shared simulation.

In some implementations, the system 100 may provide a geometric merging of environments (e.g., the first environment 110 and/or the second environment 112) for a single, unified acoustic experience for the users via the merged environment 140, e.g., coupled volumes. The joined location 136 may represent a physical opening that enables the exchange of acoustic energy in a simulation. The acoustics of each environment have a mutual influence on one another, e.g., the first environment 110 may affect the second environment 112, and the second environment 112 may affect the first environment 110. In some cases, multiple joined locations 136 may exist between a pair of environments. In some cases, multiple environments may be nested with respect to one another, e.g., the first environment may be positioned entirely inside the second environment, as shown in FIG. 7. For example, this could acoustically sound like a living room (the first environment 110) in the middle of a stadium (the second environment 112). In some cases, an environment may open multiple walls as joined locations 136 with other environments. For example, the first environment 110 may have two or more joined locations 136 with the second environment 112, each at a different location, e.g., opening multiple walls as portals. In some cases, the device (e.g., the first device) may include a wall-mounted teleconferencing camera, and an authored model of the environment could be used to determine placement of the joined location 136. In some cases, multiple sensors and/or multiple devices in the system 100 may be used to generate or update the mesh data structures representing the environments, such as via network communication, e.g., via the server device 106.

In some implementations, one or more devices in the system 100 may provide one or more teleconferencing signal enhancements to the modified acoustic signal (e.g., 138c, 142c) using the merged mesh data structure 124. This may include acoustic meshing to single-viewpoint video conferencing systems, e.g., FIG. 2A, with applications for local or networked signal processing improvements, e.g., to derive the mesh data structure 120 for the first environment 110 from a field of view in an image captured by a camera of the first device 102; and/or enhance signal processing algorithms, such as voice isolation. Some applications may include conference rooms (e.g., the first device 102 installed as part of a video conferencing system) or arbitrary rooms for users with cameras enabled (e.g., the first device 102 is a laptop, tablet, smartphone, HMD, etc. moving between environments, from location to location).

In some implementations, a device in the system 100 may utilize an algorithm for monocular metric depth and/or material segmentation to generate a mesh data structure for sensed (visible) parts of an environment (e.g., within a field of view of an image the camera of the first device 102, to generate to the first mesh data structure 120). Unsensed parts of the environment (e.g., beyond the field of view of the image, in the first environment 110) may be estimated and completed by the device based on a prediction from a trained ML model. The ML model may be trained, for example, based on a collection of environments utilized by the user.

The merged mesh data structure 124 can be utilized to perform acoustic simulations. The merged mesh data structure 124 includes a combination of individual mesh data structures (e.g., the first mesh data structure 120 and the second mesh data structure 122), each including an environment or room geometry with material and semantic classifications per surface. The merged mesh data structure 124 and/or the individual mesh data structures may be locally persisted or updated across teleconferencing sessions. In some cases, the environment may be predetermined (such as a fixed installation, e.g., the wall-mounted teleconferencing camera), and in some cases, the environment may be classified/recalled (such as a portable camera, e.g., a laptop camera or HMD). In some cases, the device (e.g., the first device 102) may detect a number of users and/or positions of users in the room, and the modified acoustic signals may be determined by the transfer functions based on the number of users and/or positions detected. The merged mesh data structure 124 and/or the individual mesh data structures may be updated based on other sensed viewpoints (e.g., laptop camera or HMD of other users) and shared with the device (e.g., the first device 102). Unsensed surfaces of the unsensed parts of the environment, e.g., the wall on which the videoconferencing camera is mounted, may then be estimated by the device to update the merged mesh data structure 124 and, in turn, the transfer functions.

In some implementations, the system may perform various algorithmic enhancements. In combination with estimation (e.g., visual, and/or acoustic) of transducer locations (e.g., users, teleconferencing microphones, sound output transducers, such as loudspeakers/speakers, and laptops), a device of the system can simulate and invert acoustic transfer functions. This may be useful, for example, to de-reverberate speech (with estimated room reverberation), as described herein. The processing may be performed locally or remotely, e.g., in the cloud. Additionally, speech identification or beamforming may be enhanced by eliminating confusion with wall reflections. This may be useful, for example, to generate a fingerprint or filter for each user. Further, a device of the system can enhance playback from the sound output transducers, e.g., videoconferencing loudspeakers. This may be useful, for example, to identify problematic surfaces or acoustic phenomena that degrade speech quality, and to compensate based on known sound output transducers positions. This may also be useful to improve initialization for echo cancellation by simulating loudspeaker to microphone paths.

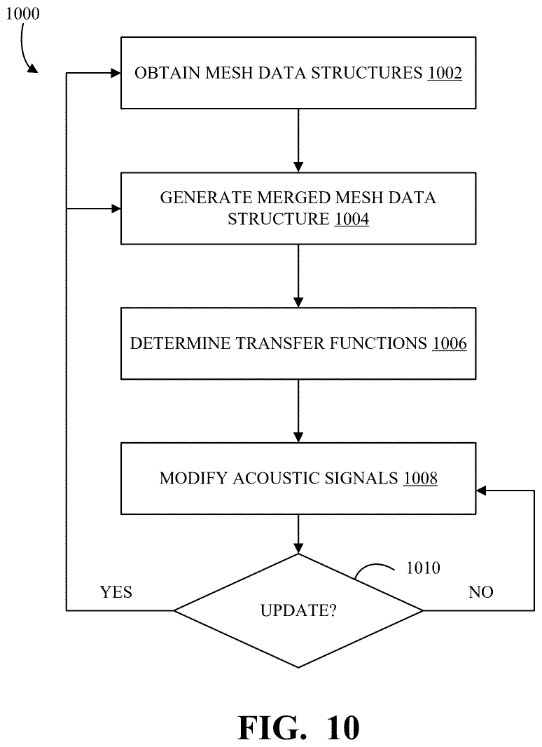

FIG. 10 shows a block diagram of hardware of a device 900, in one aspect, which may be used with any of the aspects described herein (e.g., the first device 102, the second device 104, and/or the server device 106.). This device can represent a general-purpose computer system or a special purpose computer system. Note that while FIG. 10 illustrates the various components of a device that may be incorporated into one or more of the devices described herein, it is merely one example of a particular implementation and is merely to illustrate the types of components that may be present in the system. FIG. 10 is not intended to represent any particular architecture or manner of interconnecting the components as such details are not germane to the aspects herein. It will also be appreciated that other types of devices that have fewer components than shown or more components than shown in FIG. 10 can also be used. Accordingly, the processes described herein are not limited to use with the hardware and software of FIG. 10

As shown in FIG. 10, the device (or system) 900 (for example, a wearable device, such as an HMD, glasses, smartwatch, or headphone (headset), or other device, such as a desktop computer, smart TV, smart speaker, laptop, tablet, or smartphone) includes one or more buses 902 that serve to interconnect the various components of the system. One or more processors 904 are coupled to bus 902 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 906 can include Read Only Memory (ROM), volatile memory, and non-volatile memory, or combinations thereof, coupled to the bus using techniques known in the art. Camera(s) 908, microphone(s) 910, speaker(s) 912, and display(s) 914 may be coupled to the bus 902.

Memory 906 can be connected to the bus and can include DRAM, a hard disk drive or a flash memory or a magnetic optical drive or magnetic memory or an optical drive or other types of memory systems that maintain data even after power is removed from the system. In one aspect, the processor 904 retrieves computer program instructions stored in a machine-readable storage medium (memory) and executes those instructions to perform operations described herein.

Audio hardware, although not shown, can be coupled to one or more buses 902 to receive audio signals to be processed and output (or played back) by speakers 912 (e.g., sound output transducers). Audio hardware can include digital to analog and/or analog to digital converters. Audio hardware can also include audio amplifiers and filters. The audio hardware can also interface with microphones 910 (e.g., microphone arrays) to receive audio signals (whether analog or digital), digitize them if necessary, and communicate the signals to the bus 902.

The network interface 916 may communicate with one or more remote devices and networks. For example, interface can communicate over known technologies such as Wi-Fi, 3G, 4G, 5G, Bluetooth, ZigBee, or other equivalent technologies. The interface can include wired or wireless transmitters and receivers that can communicate (e.g., receive and transmit data) with networked devices such as servers (e.g., the cloud) and/or other devices such as remote speakers and remote microphones.

It will be appreciated that in some aspects disclosed herein can utilize memory that is remote from the system, such as a network storage device which is coupled to the device through a network interface such as a modem or Ethernet interface. The buses 902 can be connected to each other through various bridges, controllers and/or adapters as is well known in the art. In one aspect, one or more network device(s) can be coupled to the bus 902. The network device(s) can be wired network devices (e.g., Ethernet) or wireless network devices (e.g., WI-FI, Bluetooth). In some aspects, various aspects described (e.g., determination, estimation, analysis, modeling, etc. ,) can be performed by a networked server in communication with the capture device.

In one aspect, although illustrated as separate components, one or more components may be a part of (or integrated) together or with an electronic device. For example, the memory 906 may be a part of one or more processors 904.

Various aspects described herein may be embodied, at least in part, in software. That is, the techniques may be carried out in an audio system in response to its processor executing a sequence of instructions contained in a storage medium, such as a non-transitory machine-readable storage medium (e.g., DRAM or flash memory). In various aspects, hardwired circuitry may be used in combination with software instructions to implement the techniques described herein. Thus, the techniques are not limited to any specific combination of hardware circuitry and software, or to any particular source for the instructions executed by the device.

Some embodiments described herein can include use of learning and/or non-learning-based process(es). The use can include collecting, pre-processing, encoding, labeling, organizing, analyzing, recommending, and/or generating data. Entities that collect, share, and/or otherwise utilize user data should provide transparency and/or obtain user consent when collecting such data. The present disclosure recognizes that the use of the data in the acoustic modeling processes described herein can be used to benefit users. For example, the data can be used to train models that can be deployed to improve performance, accuracy, and/or functionality of applications and/or services. Accordingly, the use of the data enables the acoustic modeling processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the acoustic modeling processes are also contemplated by the present disclosure.

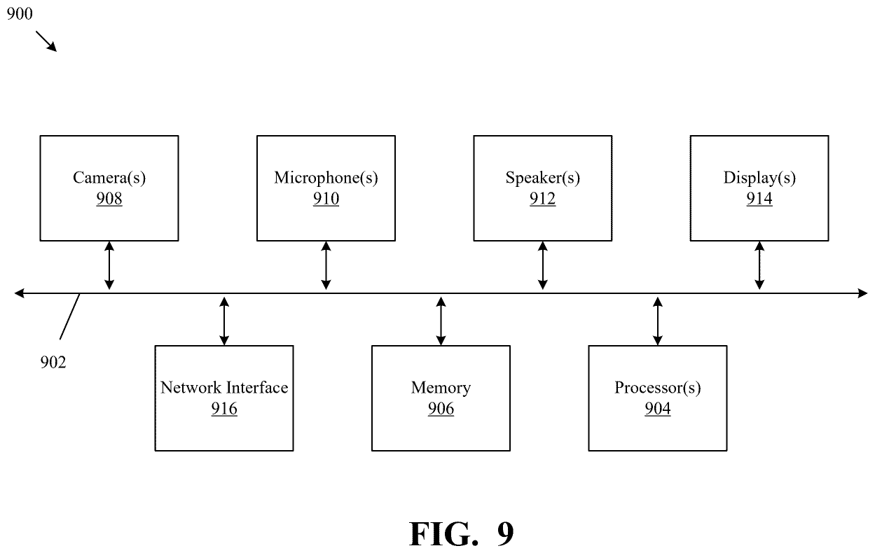

Reference is now made to flowcharts of examples of processes for acoustic joining of two or more physical or virtual environments. The processes can be executed using computing devices, such as the systems, hardware, and software described with respect to FIGS. 1-9. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

FIG. 10 is an example of a process 1000 for acoustic joining of two or more physical or virtual environments. At operation 1002, a system can obtain mesh data structures representing different environments, such as the first mesh data structure 120 representing the first environment 110 and the second mesh data structure 122 representing the second environment 112. The system may include one or more devices performing the functions, such as the first device 102, the second device 104, and/or the server device 106. One or more of the mesh data structures may be generated based on features in a field of view captured by an RGB-D image taken by a camera in communication with the device. a prediction of features beyond a field of view captured by an image. The one or more mesh data structures may be further generated based on a prediction of features beyond the field of view captured by the image. The one or more mesh data structures may be updated or refreshed by a second image and/or a second prediction, including by the same device or from another device. In some cases, one or more of the mesh data structures may be an authored or generic mesh data structure that is dynamically created, generated, or accessed from a library. In some cases, one or more of the mesh data structures may be received from another device.

At operation 1004, the system can generate a merged mesh data structure based on the mesh data structures that were obtained, such as the merged mesh data structure 124 being generated based on the first mesh data structure 120 and the second mesh data structure 122. The merged mesh data structure may represent a merged environment that joins the different environments at one or more joined locations or portals, such as the merged environment 140 joining the first environment 110 and the second environment 112 at the joined location 136. The joined location of the merged environment may be defined by areas for joined locations in the individual environments, such as the first joined location 136a and the second joined location 136b. In some cases, the system may receive input from a user that indicates an area of an environment (e.g., the first environment 110 or the second environment 112) for the joined location. In some cases, the system may receive an algorithmic analysis, state change, or metadata of an environment (e.g., the first environment 110 or the second environment 112) that indicates an area of the environment for the joined location.

At operation 1006, the system can determine one or more acoustic transfer functions between locations of the first environment and the second environment in the merged environment, such as between a first location in the first environment 110 and a second location in the second environment 112 in the merged environment 140. For example, the first location may correspond to a location of a first user speaking in the first environment and the second location may correspond to a second user listening in the second environment. In another example, the first location may correspond to a location of a first user listening in the first environment and the second location may correspond to a music performance, sporting event, crowd noise, etc., at a plurality of locations in the second environment. The system can utilize an acoustic simulator to determine the one or more acoustic transfer functions based on the merged mesh data structure.

At operation 1008, the system can modify an acoustic signal originating at a first location (e.g., picked up by a physical or virtual microphone in the first environment or the second environment, and/or a generated or prerecorded acoustic signal determined to originate at a particular location in the first environment or the second environment). The system can modify the acoustic signal with a transfer function that was determined (based on simulations using the merged mesh data structure) to produce a modified acoustic signal to be played back at a second location (e.g., by a physical or virtual sound output transducer in the other of the first environment or the second environment). The acoustic signals may be modified by a DSP function of the device. For example, a first microphone can pick up a first acoustic signal at a first location in the first environment, then modify the first acoustic signal based on a first transfer function to produce a first modified acoustic signal to be played back by a second sound output transducer to a second location in the second environment. In another example, a second microphone can pick up a second acoustic signal at the second location in the second environment, then modify the second acoustic signal based on a second transfer function to produce a second modified acoustic signal to be played back by a first sound output transducer to a first location in the first environment, e.g., a conversation between the first user and the second user. In this way, the acoustics of each environment may have a mutual influence on one another, e.g., the first environment 110 may affect the second environment 112, and the second environment 112 may affect the first environment 110.

At operation 1010, the system can determine whether to update the mesh data structures, and/or one or more parameters of one or more of the mesh data structures, including whether to add or remove one or more the mesh data structures. The system may update the mesh data structures periodically (a refresh cycle) or based on interrupts (e.g., an event, such as a third device in a third environment joining the teleconference). If the system determines to performs the update (Yes), the system may return to operations 1002 or 1004 directly. If the system determines not to perform the update (No), the system may return to operation 1008 to continue to modify acoustic signals.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

An aspect of the disclosure may include a non-transitory machine-readable medium (such as computer memory) having stored thereon instructions, which program one or more data processing components (generically referred to here as a “processor”) to automatically perform operations, as described herein. In other aspects, some of these operations might be performed by specific hardware components that contain hardwired logic. Those operations might alternatively be performed by any combination of programmed data processing components and fixed hardwired circuit components. A “processor” may include a distributed arrangement where multiple processors are configured and controlled to perform the recited operations or tasks together, e.g., one processor can perform some of the recited operations and another processor can perform others of the recited operations.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method for acoustic joining of two or more physical or virtual environments, comprising:
obtaining a first mesh data structure representing a first environment and a second mesh data structure representing a second environment;
generating a merged mesh data structure based on the first mesh data structure and the second mesh data structure, the merged mesh data structure representing a merged environment that joins the first environment with the second environment at a joined location;
determining a transfer function between locations of the first environment and the second environment in the merged environment; and
modifying an acoustic signal originating at a first location with the transfer function to produce a modified acoustic signal to be played back at a second location.

2. The method of claim 1, wherein a first user in the first environment, and a second user in the second environment, experience sound having a common room acoustic property based on the merged mesh data structure.

3. The method of claim 1, further comprising:
sending, by a first device having the first mesh data structure, the first mesh data structure, the merged mesh data structure, or one or more parameters of the first mesh data structure or the merged mesh data structure, to a second device.

4. The method of claim 1, further comprising:
receiving, by a first device having the first mesh data structure, the second mesh data structure, the merged mesh data structure, or one or more parameters of the second mesh data structure or the merged mesh data structure, from a second device.

5. The method of claim 1, wherein a server device receives the first mesh data structure from a first device and the second mesh data structure from a second device to generate the merged mesh data structure.

6. The method of claim 1, wherein the first mesh data structure is generated based on an image from a first device capturing the first environment.

7. The method of claim 1, wherein the first mesh data structure is generated based on a prediction of features beyond a field of view captured by an image.

8. The method of claim 1, wherein at least one of the first mesh data structure or the second mesh data structure is an authored or generic mesh data structure.

9. The method of claim 1, wherein a prediction of the modified acoustic signal is used to enhance de-reverberation of speech from a user.

10. The method of claim 1, further comprising:
updating the merged mesh data structure based on one or more additional mesh data structures representing one or more additional environments joined at one or more additional joined locations.

11. The method of claim 1, wherein the merged mesh data structure represents the first environment nested within the second environment.

12. The method of claim 1, further comprising:
displaying a video stream at the joined location in the first environment or the second environment.

13. The method of claim 1, further comprising:
rendering or displaying a non-video component at the joined location in the first environment or the second environment.

14. The method of claim 1, further comprising:
receiving input from a user that indicates an area of the first environment or the second environment for the joined location.

15. The method of claim 1, further comprising:
receiving an algorithmic analysis, state change, or metadata of the first environment or the second environment that indicates an area of the first environment or the second environment for the joined location.

16. The method of claim 1, wherein the acoustic signal is modified and played back to emulate a virtual sound source positioned in the merged environment.

17. The method of claim 1, wherein the transfer function is between a first location in the first environment and a second location in the second environment.

18. A system for acoustic joining of two or more physical or virtual environments, comprising:
a microphone;
a sound output transducer; and
a processor configured to:
obtain a first mesh data structure representing a first environment and a second mesh data structure representing a second environment;
generate a merged mesh data structure based on the first mesh data structure and the second mesh data structure, the merged mesh data structure representing a merged environment that joins the first environment with the second environment at a joined location;
determine a transfer function between locations of the first environment and the second environment in the merged environment; and
modify an acoustic signal originating at a first location with the transfer function to produce a modified acoustic signal to be played back at a second location.

19. The system of claim 18, wherein at least one of the first mesh data structure or the second mesh data structure is generated based on prediction.

20. The system of claim 18, wherein at least one of the first mesh data structure or the second mesh data structure is generated based on an image captured by a third device.
